(19) United States
(12) Patent Application Publication
(10) Pub. No.: US 2005/0135012 A1
(43) Pub. Date: Jun. 23, 2005

(54) Head slider, magnetic storage apparatus and head slider producing method

(75) Inventor: Hiroyuki Kubotera, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 10/893,985

(22) Filed: Jul. 20, 2004

(30) Foreign Application Priority Data
Dec. 17, 2003 (JP) 2003-420080

(51) Int. Cl. G11B 5/60

(52) U.S. Cl. 360/236.3

(57) ABSTRACT

A head slider has a medium opposing surface configured to confront and float from a surface of a recording medium. A front rail is disposed on the medium opposing surface in a vicinity of an air inlet end and has a first air bearing surface and a first step surface which forms a stepped portion with the first air bearing surface which is higher than the first step surface relative to the medium opposing surface. A rear rail is disposed on the medium opposing surface in a vicinity of an air outlet end and has a second air bearing surface and a second step surface which forms a stepped portion with the second air bearing surface which is higher than the second step surface relative to the medium opposing surface. The first air bearing surface is substantially surrounded by the first step surface.

### BACKGROUND OF THE INVENTION

This application claims the benefit of a Japanese Patent Application No. 2003-420080 filed Dec. 17, 2003, in the Japanese Patent Office, the disclosure of which is hereby incorporated by reference.

1. Field of the Invention

The present invention generally relates to head sliders, magnetic storage apparatuses and head slider producing methods, and more particularly to a flying type head slider for use in a hard disk drive or optical storage apparatus, a magnetic storage apparatus which uses such a head slider, and a head slider producing method for producing such a head slider.

2. Description of the Related Art

Magnetic storage apparatuses, such as hard disk drives, are popularly used as external magnetic storages for computers, household video storage units, navigation equipments and the like. Recently, there are increased opportunities to record extremely large amounts of information, such as dynamic images, and there are increased demands to increase the storage capacity, to increase the operation speed and to reduce the cost. In order to satisfy such demands, active research is being made to develop recording and reproducing techniques which enable high-density recording on magnetic recording media.

In the recording and reproducing techniques, it is important to improve the write and read performance of a magnetic head and to reduce the flying height of the magnetic head, in correspondence with the increased recording density of the magnetic recording medium. The magnetic head is provided on a head slider which is supported on a head suspension. The magnetic head carries out the recording and reproducing operations by floating from the surface of the magnetic recording medium by maintaining the flying height on the order of ten-odd μm. This flying height is maintained by the balance of an air force and a pushing force.

The air force is generated by an air flow that is generated by the rotation of the magnetic recording medium, such as a magnetic disk, and is received by a medium opposing surface of the head slider confronting the surface of the magnetic recording medium. On the other hand, the pushing force is generated by the head suspension and acts on the head slider in a direction so as to push the medium opposing surface of the head slider towards the surface of the magnetic recording medium. The air force is generated mainly by an air bearing surface which is located at a highest portion of the medium opposing surface of the head slider. In other words, the air bearing surface receives a floating force due to a pressure which increases due to the air flow sandwiched between the air bearing surface and the surface of the magnetic recording medium.

The flying height of the magnetic head refers to a distance from the surface of the magnetic recording medium to a magnetic head element of the magnetic head. In order to realize a high-density recording, it is necessary to reduce the flying height, because a spacing loss at the time of the recording and reproduction is directly related to the flying height. That is, when the flying height is small, the magnetic head element can sense more magnetic flux leaking from a recording layer of the magnetic recording medium at the time of the reproduction, and satisfactory record information on the recording layer at the time of the recording.

Recently, hard disk drives which enable a surface recording density exceeding 80 Gbit/in² have been developed. In such hard disk drives, the flying height of the magnetic head is set to an extremely small amount on the order of ten-odd nm in order to obtain a sufficiently high signal-to-noise ratio (SNR). When the flying height is extremely small, it is necessary to control various flying height varying factors which affect and vary the flying height with an extremely high precision compared to the case where the flying height is on the order of several tens of nm.

One of the flying height varying factors is the precision with which the air bearing surface and a step surface which is one step lower than the air bearing surface are formed when forming the medium opposing surface of the head slider. The medium opposing surface of the head slider may be formed by a process similar to a semiconductor forming process. That is, a resist layer is coated on a medium opposing surface of a wafer bar which is cut from a wafer, and a patterning is performed by an exposure apparatus using a photomask having the shape of the air bearing surface. When performing the patterning, the photomask and the wafer bar are aligned, but an alignment error on the order of several μm occurs. As a result, the area of the air bearing surface may deviate from a designed value due to the alignment error, and make it impossible to obtain a desired flying height and deteriorate the yield of the head slider. In addition, when such a head slider is used in the hard disk drive, the magnetic head may crash against the surface of the magnetic recording medium.

It is conceivable to modify the alignment technique used in the exposure apparatus to a technique which reduces the alignment error. However, this would require drastic modifications with regard to controlling the dimensions of a photomask alignment mechanism of the exposure apparatus, controlling the dimensions of the wafer bar, designing a fixing jig for the wafer bar, and the like. Hence, it is impractical to make such drastic modifications which are both troublesome and time-consuming.

### SUMMARY OF THE INVENTION

Accordingly, it is a general object of the present invention to provide a novel and useful head slider, magnetic storage apparatus head slider producing method, in which the problems described above are suppressed.

Another and more specific object of the present invention is to provide a head slider which has a stable floating characteristic even when a flying height is small, is suited for high-density recording and can be produced with a high yield, and to provide a magnetic storage apparatus which uses such a head slider and a head slider producing method for producing such a head slider.

Still another object of the present invention is to provide a head slider comprising a medium opposing surface configured to confront and float from a surface of a recording medium, the medium opposing surface having an air inlet end and an air outlet end with respect to an air flow between the medium opposing surface and the recording medium; a front rail, disposed on the medium opposing surface in a vicinity of the air inlet end, and having a first air bearing surface and a first step surface which forms a stepped portion with the first air bearing surface, the first air bearing surface being higher than the first step surface relative to the medium opposing surface; and a rear rail, disposed on the medium opposing surface in a vicinity of the air outlet end, and having a second air bearing surface and a second step surface which forms a stepped portion with the second air bearing surface, the second air bearing surface being higher than the second step surface relative to the medium opposing surface, the first air bearing surface being substantially surrounded by the first step surface. According to the head slider of the present invention, it is possible to obtain a stable floating characteristic even when the flying height is small, and the head slider is suited for high-density recording. Further, the head slider can be produced with a high yield.

A further object of the present invention is to provide a magnetic storage apparatus comprising a recording medium having a surface; and a head slider configured to be movable with respect to the recording medium at a floating distance from the surface of the recording medium, the head slider comprising a medium opposing surface configured to confront and float from the surface of the recording medium, the medium opposing surface having an air inlet end and an air outlet end with respect to an air flow between the medium opposing surface and the recording medium; a front rail, disposed on the medium opposing surface in a vicinity of the air inlet end, and having a first air bearing surface and a first step surface which forms a stepped portion with the first air bearing surface, the first air bearing surface being higher than the first step surface relative to the medium opposing surface; and a rear rail, disposed on the medium opposing surface in a vicinity of the air outlet end, and having a second air bearing surface and a second step surface which forms a stepped portion with the second air bearing surface, the second air bearing surface being higher than the second step surface relative to the medium opposing surface, the first air bearing surface being substantially surrounded by the first step surface. According to the magnetic storage apparatus of the present invention, it is possible to obtain a stable floating characteristic of the head slider even when the flying height is small, thereby making the magnetic storage apparatus suitable for high-density recording. Further, the magnetic storage apparatus can be produced with a high yield because the head slider can be produced with a high yield.

Another object of the present invention is to provide a head slider producing method comprising the steps of (a) forming a first resist layer pattern on a medium opposing surface of a block which includes a head element and is to form a head slider; (b) etching the medium opposing surface using the first resist layer pattern as a mask to form an air bearing surface; (c) removing the first resist layer pattern and forming a second resist layer pattern which is larger than the air bearing surface and completely covers the air bearing surface; and (d) etching the medium opposing surface using the second resist layer pattern as a mask to form a step surface which forms a stepped portion with the air bearing surface, so that the air bearing surface is substantially surrounded by the step surface. According to the head slider producing method of the present invention, it is possible to produce a head slider which can obtain a stable floating characteristic even when the flying height is small, and is suited for high-density recording. Further, the head slider can be produced with a high yield.

Other objects and further features of the present invention will be apparent from the following detailed description when read in conjunction with the accompanying drawings.

### BRIEF DESCRIPTION OF THE DRAWINGS

FIG. 1 is a diagram showing an embodiment of a head slider according to the present invention in a state floating from a magnetic recording medium;

FIG. 2 is a perspective view showing the embodiment of the head slider;

FIG. 3 is a diagram showing a medium opposing surface of the head slider shown in FIG. 2;

FIG. 4 is a cross sectional view of the head slider along a line X-X′ in FIG. 3;

FIGS. 5A and 5B are diagrams for explaining an embodiment of a head slider producing method for producing the embodiment of the head slider;

FIGS. 6A through 6D are diagrams for explaining the embodiment of the head slider producing method for producing the embodiment of the head slider;

FIG. 7 is a diagram showing a medium opposing surface of a modification of the embodiment of the head slider according to the present invention;

FIG. 8 is a diagram showing a medium opposing surface of a comparison example of a head slider;

FIG. 9 is a diagram showing floating characteristics of the embodiment of the head slider and the comparison example of the head slider; and

FIG. 10 is a plan view showing a part of an embodiment of a magnetic storage apparatus according to the present invention.

### DESCRIPTION OF THE PREFERRED EMBODIMENTS

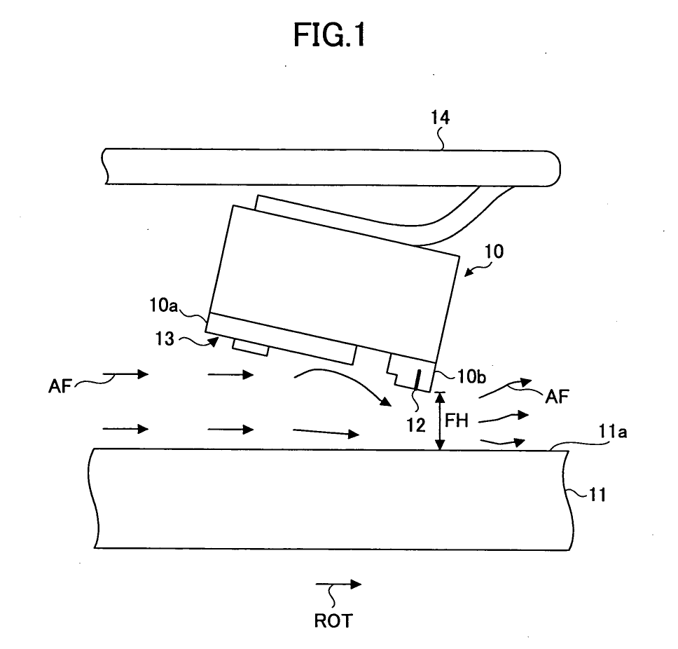

A description will be given of embodiments of a head slider according to the present invention, a magnetic storage apparatus according to the present invention and a head slider producing method according to the present invention, by referring to FIGS. 1 through 10.

FIG. 1 is a diagram showing an embodiment of the head slider according to the present invention in a state floating from a magnetic recording medium. A head slider 10 shown in FIG. 1 is supported on a head suspension 14, and confronts a surface 11a of a magnetic recording medium 11. In this embodiment, the magnetic recording medium 11 is a magnetic disk. When the magnetic recording medium 11 rotates in a direction ROT indicated by an arrow, an air flow AF is generated as indicated by arrows. Hence, the head slider 10 floats in a position where an air inlet end 10a of the head slider 10 is floats from the surface 11a of the magnetic recording medium 11 by an amount larger than an air outlet end 10b of the head slider 10. A medium opposing surface 13 of the head slider 10 has a head element 12, provided in a vicinity of the air outlet end 10b, for recording information on and reproducing information from the magnetic recording medium 11. A flying height (or height) FH is a distance from the surface 11a of the magnetic recording medium 11 to the head element 12. Stable recording and reproducing characteristics can be obtained for high-density recording, by stably maintaining the flying height FH to a desired value. The head slider 10 suppresses variation in the flying height FH even when a processing error is introduced during the production process of the head slider 10.

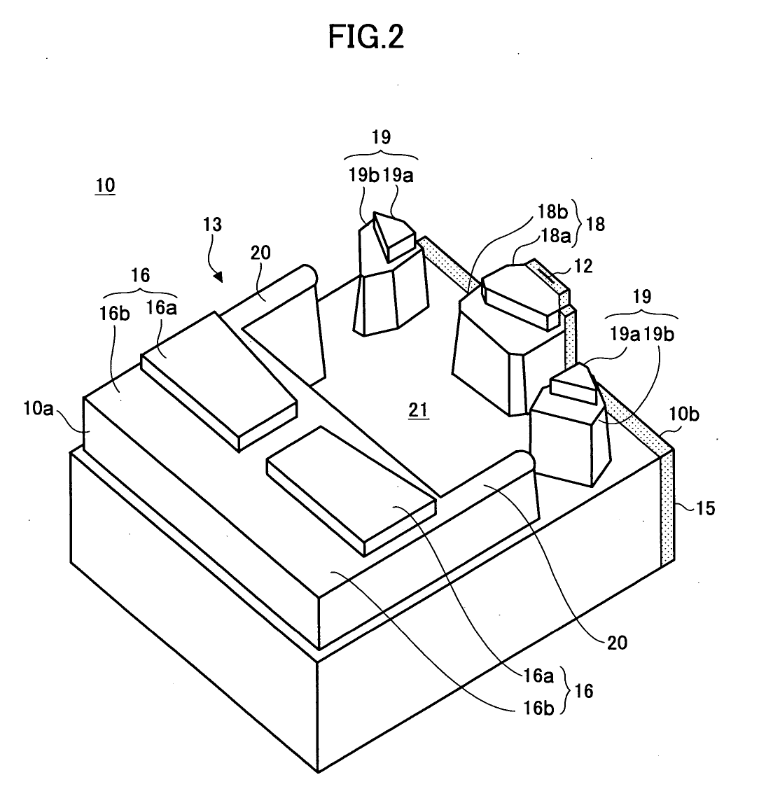

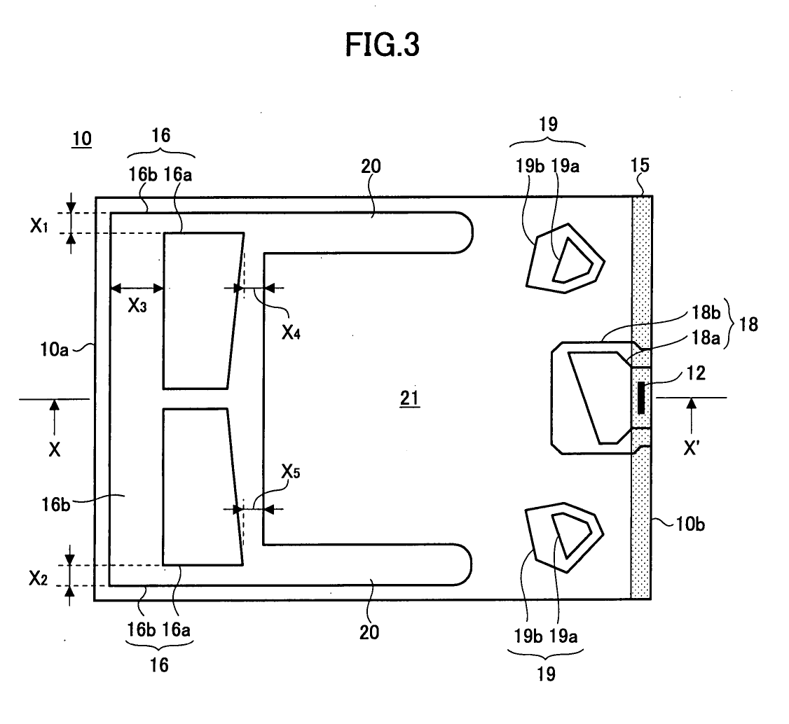

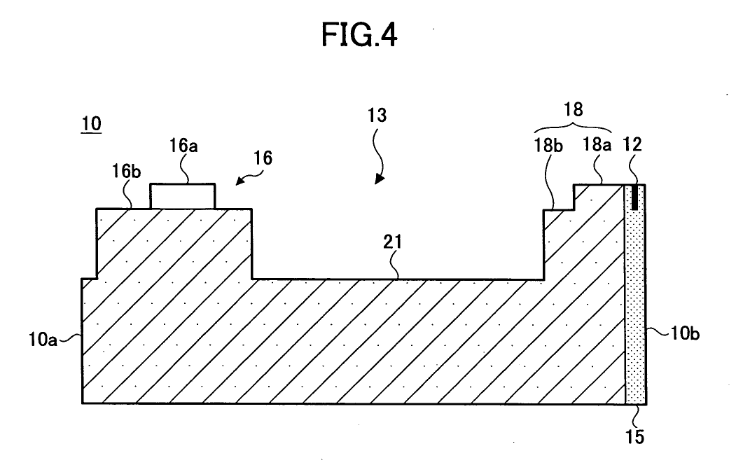

FIG. 2 is a perspective view showing the embodiment of the head slider. FIG. 3 is a diagram showing a medium opposing surface of the head slider shown in FIG. 2, and FIG. 4 is a cross sectional view of the head slider along a line X-X′ in FIG. 3. As may be seen from FIGS. 2 through 4, the head slider 10 has an approximate parallelepiped shape having a length of 1.25 mm, a width of 1.00 mm and a height of 0.30 mm, for example. The length is taken in the horizontal direction in FIG. 3, the width is taken in a vertical direction in FIG. 3, and the height is taken in a vertical direction in FIG. 4. The head slider 10 is made of a material such as Al₂O₃—TiC (allitic). A protection layer made of Diamond-Like-Carbon (DLC) may be formed on the medium opposing surface 13 of the head slider 10. In addition, an alumina (Al₂O₃) layer 15 having a thickness of several tens of μm covers the head element 12 at the air outlet end 10b of the head slider 10.

A front rail 16 is provided on the medium opposing surface 13 of the head slider 10 in a vicinity of the air inlet end 10a. A rear center rail 18 is provided on the medium opposing surface 13 in a vicinity of the air outlet end 10b. A pair of rear side rails 19 are provided on the medium opposing surface 13 on respective sides of the head slider 10 relative to the rear center rail 18. The rear center rail 18 is closer to the air outlet end 10b than the rear side rails 19.

The front rail 16 includes air bearing surfaces 16a each extending in a direction taken along the width of the head slider 10, and a step surface 16b which is lower than the air bearing surfaces 16a and forms a stepped portion with the air bearing surfaces 16a. In this embodiment, each air bearing surface 16a spreads towards the corresponding closer side of the head slider 10, as shown in FIGS. 2 and 3. For example, the step surface 16b is approximately 0.2 μm lower than the air bearing surface 16a, as shown in FIGS. 2 and 4. The air bearing surfaces 16a have the highest height of the medium opposing surface 13. The shape and dimensions of each air bearing surface 16a may be appropriately set to suit the flying height and the floating position such as a pitch angle and a roll angle. The step surface 16b is formed so as to substantially surround each of the air bearing surfaces 16a. In other words, the step surface 16b exists on both sides of each air bearing surface 16a in the direction taken along the width of the head slider 10, and in front and rear of each air bearing surface 16a respectively closer to the air inlet end 10a and the air outlet end 10b of the head slider 10.

The pitch angle is the angle formed by the medium opposing surface 13 of the head slider 10 and the surface 11a of the magnetic recording medium 11. On the other hand, the roll angle is the angle for which the head slider 10 turns about a center axis of the head slider 10 extending along a longitudinal direction thereof.

The rear center rail 18 includes an air bearing surface 18a approximately at a center in the direction taken along the width of the head slider 10, and a step surface 18b which is lower than the air bearing surface 18a and forms a stepped portion with the air bearing surface 18a. The head element 12 is provided on the air bearing surface 18a closer to the air outlet end 10b of the head slider 10. The step surface 18b is formed so as to substantially surround the front and sides of the air bearing surface 18a, but not the rear closer to the air outlet end 10b of the head slider 10. In other words, the step surface 18b exists on both sides of the air bearing surface 18a in the direction taken along the width of the head slider 10, and in front of the air bearing surface 18a closer to the air inlet end 10a of the head slider 10.

For example, the head element 12 is made up of a Giant Magneto Resistive (GMR) reproducing element and a thin film inductive recording element (both not shown) which are stacked in this order on the rear center rail 18. Of course, a Ferromagnetic Tunnel Junction Magneto Resistive (TMR) element, a ballistic MR element and the like may be used in place of the GMR reproducing element of the head element 12. Further, a ring head, a single-pole head for perpendicular magnetic recording and the like may be used in place of the thin film inductive recording element.

Each rear side rail 19 includes an air bearing surface 19a, and a step surface 19b which is lower than the air bearing surface 19a and forms a stepped portion with the air bearing surface 19a. In each rear side rail 19, the step surface 19b is formed so as to substantially surround the air bearing surface 19a.

A pair of side rails 20 on both sides in the direction taken along the width of the head slider 10. Each side rail 20 extends from the front rail 16 towards the air outlet end 10b of the head slider 10. Each side rail 20 has the same height as the step surface 16b of the front rail 16. A width of each side rail 20 in the direction taken along the width of the head slider 10 is approximately 30 μm, for example.

A groove 21 is formed in the rear of the front rail 16 closer to the air outlet end 10b. For example, the groove 21 has a depth of approximately 2 μm to approximately 3 μm from the air bearing surfaces 16a.

Next, a description will be given of a floating mechanism of the head slider 10. First, a basic floating mechanism generates an air flow along the surface 11a of the magnetic recording medium 11 when the magnetic recording medium 11 rotates. The air flow hits the stepped portions formed by the step surfaces 16b, 18b and 19b and the corresponding air bearing surfaces 16a, 18a and 19a, and thereafter acts on the air bearing surfaces 16a, 18a and 19a. Hence, a floating force corresponding to a sum of products of a pressure received from the air flow and areas of the air bearing surfaces 16a, 18a and 19a is generated. This floating force acts on the medium opposing surface 13 of the head slider 10, so as to push the head slider 10 away from the surface 11a of the magnetic recording medium 11. On the other hand, a negative pressure is generated by the groove 21, so as to generate a force in a direction opposite to the floating force. This force in the direction opposite to the floating force acts on the medium opposing surface 13 of the head slider 10, so as to draw the head slider 10 closer to the surface 11a of the magnetic recording medium 11. The head slider 10 floats from the surface 11a of the magnetic recording medium 11, with the desired flying height and floating position, due to the balancing of the floating force and the force in the direction opposite to the floating force. Accordingly, a change in the areas of the air bearing surfaces 16a, 18a and 19a causes the flying height of the head slider 10 to vary.

More particularly, the air flow first hits the stepped portion formed by the step surface 16b and the air bearing surfaces 16a of the front rail 16, and the air flow is compressed by the collision with the stepped portion to increase the pressure. The increased pressure of the air flow acts on the air bearing surfaces 16a to thereby generate the floating force. Then, the air flow reaches the groove 21 and is expanded in the direction taken along the width of the head slider 10, to thereby generate the negative pressure and the force acting in the direction opposite to the floating force. Thereafter, the air flow hits the stepped portions formed by the step surfaces 19b and the air bearing surfaces 19a of the rear side rails 19 and the stepped portion formed by the step surface 18b and the air bearing surface 18a of the rear center rail 18. Hence, similarly to the air flow hitting the stepped portion of the front rail 16, the floating forces are generated by the stepped portions of the rear side rails 19 and the rear center rail 18. The floating force generated at the front rail 16 is greater than a combined floating force generated at the rear side rails 19 and the rear center rail 18. Hence, when the surface 11a of the magnetic recording medium 11 shown in FIG. 1 is taken as a reference height, the floating position of the head slider 10 is such that the air inlet end 10a is higher than the air outlet end 10b and the pitch angle is approximately 200 μrad, for example.

At the front rail 16, the areas of the air bearing surfaces 16a are set large, so as to generate a floating force greater than the combined floating force generated at the rear side rails 19 and the rear center rail 18. A portion of the step surface 16b partitions the central part of the air bearing surface of the front rail 16 into the two air bearing surfaces 16a, as shown in FIGS. 2 and 3. However, it is not essential to provide such a portion of the step surface 16b, and the front rail 16 may have a single air bearing surface 16a. The distances from the surface 11a of the magnetic recording medium 11 to the rear side rails 19 and the rear center rail 18 are shorter than the distance from the surface 11a to the front rail 16, as may be seen from FIG. 1. For this reason, the pressure of the air flow is greater at the rear side rails 19 and the rear center rail 18 when compared to that at the front rail 16, and even a small change in the areas of the air bearing surfaces 19a and 18a greatly affects the floating forces that are generated.

In addition, the rear side rails 19 provided on both sides of the head slider 10 have the function of maintaining the floating position of the head slider 10 to a roll angle within a predetermined range, even when the magnetic recording medium 11 is a magnetic disk and the head slider 10 is located at the inner or outer peripheral portion of the magnetic disk and an angle of the air flow reaching the head slider 10 changes. This angle of the air flow reaching the head slider 10 is the angle formed by the direction of the air flow and the longitudinal direction of the head slider 10. The longitudinal direction of the head slider 10 is the horizontal direction in FIG. 3. Accordingly, the floating stability of the head slider 10 is improved by controlling the floating force at each of the rear side rails 19 to a predetermined range.

As described above, in the head slider 10 of this embodiment, the air bearing surfaces 16a of the front rail 16 are surrounded by the step surface 16b. For this reason, as will be described later in conjunction with the production process of the head slider 10, the area of the air bearing surfaces 16a does not change even if an alignment error of a photomask for forming the air bearing surfaces 16a occurs. Accordingly, it is possible to prevent the floating force generated at the front rail 16 from varying.

Widths of the step surfaces 16b, 18b and 19b surrounding the corresponding air bearing surfaces 16a, 18a and 19a in FIG. 3 are set as follows. The width of each of the step surfaces 16b, 18b and 19b surrounding the corresponding air bearing surfaces 16a, 18a and 19a refers to a distance between an end portion of each of the step surfaces 16b, 18b and 19b and a boundary portion of between each of the step surfaces 16b, 18b and 19b and the corresponding air bearing surfaces 16a, 18a and 19a. For example, minimum widths X1 through X5 of the step surface 16b surrounding the air bearing surfaces 16a in FIG. 3, with respect to each side of the air bearing surfaces 16a, are set to 1 μm or greater by taking into consideration the alignment error during the exposure process which will be described later. The minimum widths X1 through X5 are preferably 5 μm or greater, and more preferably 10 μm or greater. The upper limit of each of the minimum widths X1 through X5 may be set appropriately depending on the position and the designed flying height. For example, the upper limit of the minimum widths X1 and X2 is 30 μm, the upper limit of the minimum width X3 is 100 μm, and the upper limit of the minimum widths X4 and X5 is 50 μm. The effects of surrounding the air bearing surfaces 16a by the step surface 16b are particularly notable, because the air bearing surfaces 16a of the front rail 16 are longer and wider than the air bearing surfaces 19a and 18a of the rear side rails 19 and the rear center rail 18.

In the rear center rail 18, the step surface 18b surrounds the air bearing surface 18a except for the end portion of the surface 18a on the side of the air outlet end 10b provided with the head element 12. Similarly to the front rail 16, a minimum width of the step surface 18b surrounding the air bearing surface 18a is set to 1 μm or greater, and preferably to 5 μm or greater, and more preferably to 10 μm or greater.

In each of the rear side rail 19, the step surface 19b surrounds the air bearing surface 19a. Similarly to the front rail 16, a minimum width of the step surface 19b surrounding the air bearing surface 19a is set to 1 μm or greater, and preferably to 5 μm or greater, and more preferably to 10 μm or greater.

By setting the minimum widths of the step surfaces 16b, 18b and 19b surrounding the corresponding air bearing surfaces 16a, 18a and 19a, it is possible to suppress variation of the flying height caused by an alignment error of the patterning at the time of forming the air bearing surfaces 16a, 18a and 19a and the step surfaces 16b, 18b and 19b, as will be described later.

Of course, the shape of the air bearing surfaces 16a is not limited to that shown in FIG. 2. For example, the air bearing surfaces 16a may have an appropriate shape, such as a rectangular shape, in place of the trapezoidal shape shown in FIG. 2. In addition, the front or leading edge of the air bearing surface 16a may be perpendicular to or, inclined or curved with respect to the air flow. Similarly, the rear or trailing edge of the air bearing surface 16a may be perpendicular to or, inclined or curved with respect to the air flow. Furthermore, it is not essential for the side edges of the air bearing surface 16a to be parallel with respect to the air flow.

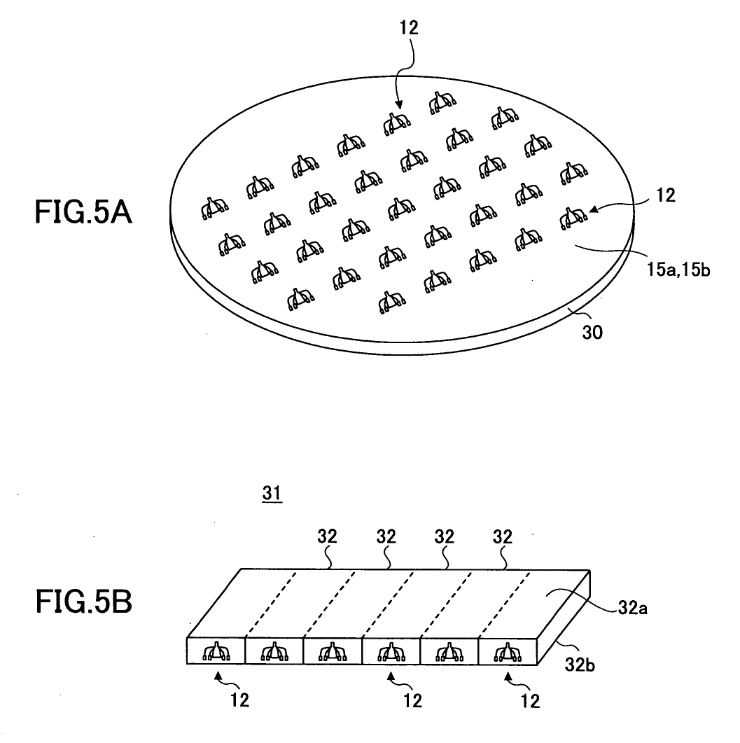

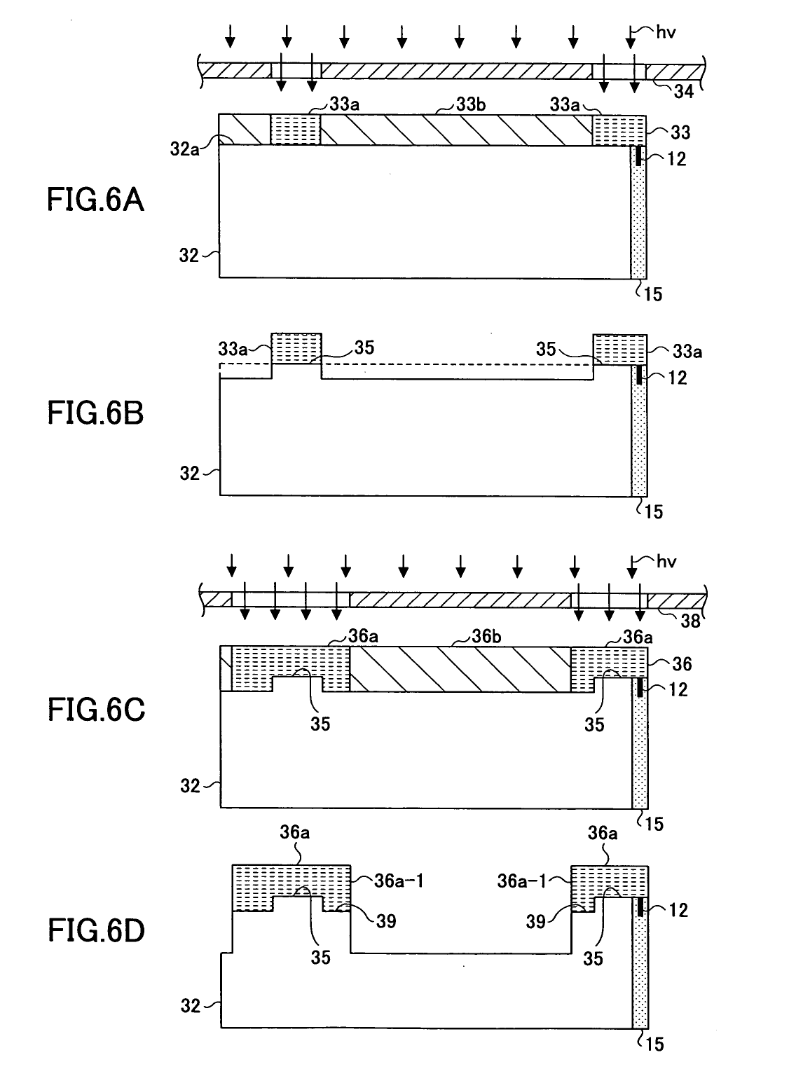

Next, a description will be given of an embodiment of the head slider producing method according to the present invention, by referring to FIGS. 5A, 5B and 6A through 6D. FIGS. 5A, 5B and 6A through 6D are diagrams for explaining this embodiment of the head slider producing method. FIGS. 6A through 6D show cross sections of a block which forms one head slider.

In a process shown in FIG. 5A, an allitic wafer 30 is used as a substrate. An alumina layer 15a is formed on the wafer 30 to cover the surface of the wafer 30. Then, a plurality of head elements 12 are formed in a matrix arrangement on the surface of the alumina layer 15a. Each head element 12 is made up of a GMR reproducing element and a thin film inductive recording element which are stacked. An alumina layer 15b is formed on the alumina layer 15a to a thickness of 5 μm to 20 μm, for example, to cover the head elements 12. An aluminum nitride layer may be used in place of the alumina layer 15b.

Next, in a process shown in FIG. 5B, the wafer 30 is cut into rows of head elements 12, that is, wafer bars 31. Each wafer bar 31 has the row of head elements 12. In other words, each wafer bar 31 is made up of a plurality of blocks 32 which are to be later separated along dotted lines shown in FIG. 5B. Each block 32 has one head element 12 provided on an end thereof, and in this particular case, a top cut surface 32a forms the medium opposing surface and a bottom cut surface 32b forms a surface which is to be fixed to the head suspension. The cut surface of the block 32, which is to form the medium opposing surface, is determined by the orientation of the head element 12.

Thereafter, in a process shown in FIG. 6A, the cut surface 32a of the block 32 is polished and planarized, before forming a negative type resist layer 33 on the cut surface 32a. The resist layer 33 is the patterned. This patterning is performed by aligning a photomask 34 to a predetermined reference position using a reducing optical system exposure apparatus, for example. The photomask 34 is printed with patterns of the air bearing surfaces 16a, 18a and 19a. The resist layer 33 is exposed via the photomask 34 by irradiating an ultraviolet ray, for example, so as to form exposed portions 33a and a non-exposed portion 33b.

In a process shown in FIG. 6B, the resist layer 33 is developed by use of a dip developing apparatus or the like, so as to remove the non-exposed portion 33b. As a result, the exposed portions 33a having the shapes of the air bearing surfaces 16a, 18a and 19a remain on the cut surface 32a. Next, the exposed portions 33a are used as masks to remove a portion of the block 32 by Reactive Ion Etching (RIE), for example, including the alumina layers 15a and 15b, as indicated by a dotted line. Hence, portions covered by the exposed portions 33a, namely, air bearing surfaces 35, remain after the RIE. The etching amount (depth) is set slightly larger than the heights of the stepped portions formed by the step surfaces 16b, 18b and 19b and the corresponding air bearing surfaces 16a, 18a and 19a, so as to secure an amount (thickness) of the air bearing surface 35 that is finally polished in a later process. When the air bearing surface 35 will not be polished in a later process, the etching amount (depth) may be set equal to the height of the corresponding stepped portion.

In a process shown in FIG. 6C, the exposed portions 33a of the resist layer 33 are removed, and a resist layer 36 is newly formed. The resist layer 36 is the patterned. This patterning is performed by aligning a photomask 38 to a predetermined reference position using the reducing optical system exposure apparatus, for example, similarly as in FIG. 6A when forming the air bearing surfaces 35. The photomask 38 is printed with patterns of the front rail 16, the rear center rail 18 and the rear side rails 19. The resist layer 36 is exposed via the photomask 38 by irradiating an ultraviolet ray, for example, so as to form exposed portions 36a and a non-exposed portion 36b.

In a process shown in FIG. 6D, the resist layer 36 is developed by use of a dip developing apparatus or the like, so as to remove the non-exposed portion 36b. As a result, the exposed portions 36a remain on the cut surface 32a. Next, the exposed portions 36a are used as masks to remove a portion of the block 32 by RIE, for example, to a depth of the groove 21 shown in FIG. 2, so as to form step surfaces 39 which form stepped portions with the air bearing surfaces 35. Consequently, the step surfaces 39 formed substantially surround the corresponding air bearing surfaces 35. Although not shown in FIG. 6D, the exposed portions 36a of the resist layer 36 are removed, and the air bearing surfaces 35 are polished, so as to adjust the tip end of the head element 12 and the stepped portions of the air bearing surfaces 16a, 18a and 19a. The medium opposing surface 13 of the head slider 10 is completed in this manner.

The head slider 10 is then fixed to the head suspension 14, and subjected to quality inspection. The quality inspection is performed to check whether or not the flying height of the head slider 10 is within a designed range, and only the head sliders 10 belonging to the acceptable wafer lot are used as parts for the magnetic storage apparatus.

When exposing the resist layers using the masks as described above, the photomasks 34 and 38 must be aligned when forming the air bearing surfaces 35 and when forming the step surfaces 39. When aligning the photomask 34 for forming the air bearing surface and the photomask 38 for forming the step surface which forms the step portion with the air bearing surface, an alignment error on the order of several μm or greater may occur. But in the head slider 10 of this embodiment, even if a relative alignment error of the photomasks 34 and 38 occurs, the area of the air bearing surface 35 is virtually suppressed completely from varying, because the air bearing surface 35 is substantially surrounded by the step surface 39. As a result, it is possible to substantially suppress the flying height of the head slider 10 from varying due to the alignment error of the photomasks 34 and 38.

In addition, when performing the etching to form the step surface 39 in FIG. 6D, even if the an error in the patterning of the resist layer 36 occurs due to the alignment error of the photomask 38, it is possible to virtually avoid the air bearing surface 35 from being exposed. Thus, it is possible to prevent the air bearing surface 35 from being etched when forming the step surface 39.

Furthermore, in a case where a sidewall surface 36a-1 at the opening of the resist layer 36 is tapered in FIG. 6D, the step surface 39 at the tapered portion is etched due to the deteriorated resist performance at the sidewall surface 36a-1. As a result, the end portion of the step surface 39 recedes, thereby making the area of the step surface 39 smaller than the designed value. But even in such a case, the air bearing surfaces 16a of the front rail 16 shown in FIG. 3 having the large area (large length and width) are completely surrounded by the step surface 16b in the head slider 10 of this embodiment. Consequently, the air bearing surfaces 16a will not be etched simultaneously as the step surface 16b, thereby making it possible to prevent the flying height from varying.

Therefore, it is possible to realize a head slider which is suited for high-density recording and has a flying height which is suppressed from varying greatly. Moreover, it is possible to realize a head slider which can be produced at a high yield.

In the processes described above in conjunction with FIGS. 5A, 5B and 6A through 6D, only the air bearing surfaces 35 and the step surfaces 39 are described, and the description of each of the air bearing surfaces 16a, 18a and 19a and the corresponding step surfaces 16b, 18b and 19b is omitted. However, as may be seen from these figures, all of the air bearing surfaces 16a, 18a and 19a may be formed simultaneously in the process shown in FIG. 6B, and all of the corresponding step surfaces 16b, 18b and 19b which form the stepped portions with the air bearing surfaces 16a, 18a and 19b may be formed simultaneously in the process shown in FIG. 6D. Hence, the air bearing surfaces 16a, 18a and 19a can be formed to the same height with a satisfactory planar characteristic. Similarly, the step surfaces 16b, 18b and 19b can be formed to the same height with a satisfactory planar characteristic.

Of course, at least one of the air bearing surfaces 16a, 18a and 19a may be formed separately to a height which his different from the height of the other air bearing surfaces. Similarly, at least one of the step surfaces 16b, 18b and 19b may be formed separately to a height which is different from the height of the other step surfaces. In other words, the air bearing surfaces 16a, 18a and 19a may have different heights, and the step surfaces 16b, 18b and 19b may have different heights.

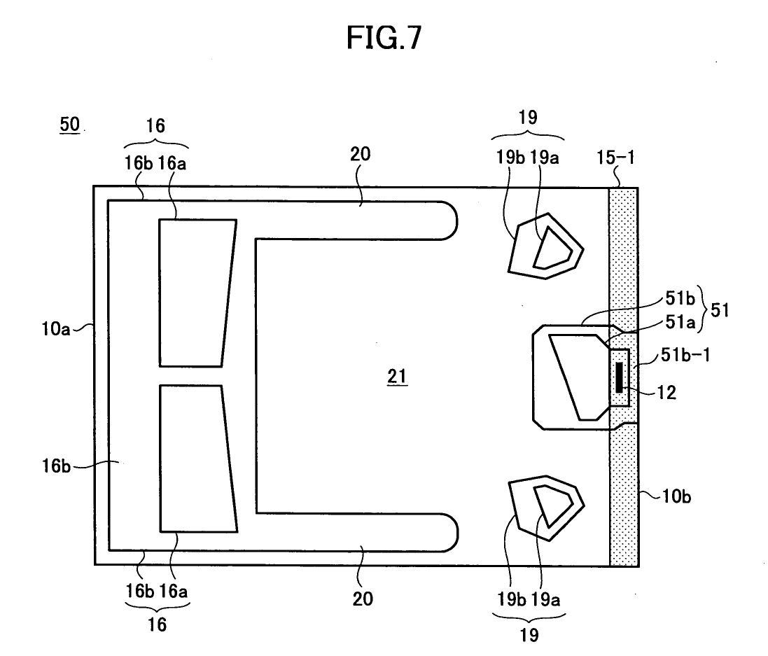

Next, a description will be given of a modification of the embodiment of the head slider according to the present invention, by referring to FIG. 7. FIG. 7 is a diagram showing a medium opposing surface of this modification of the embodiment of the head slider. In FIG. 7, those parts which are the same as those corresponding parts in FIGS. 1 through 4 are designated by the same reference numerals, and a description thereof will be omitted.

This modification shown in FIG. 7 is basically the same as the embodiment described above, except that a head slider 50 is provided with rear center rail 51 in place of the rear center rail 18. The rear center rail 51 is provided on the medium opposing surface 13 in a vicinity of the air outlet end 10b. The rear center rail 51 includes an air bearing surface 51a approximately at a center in the direction taken along the width of the head slider 50, and a step surface 51b which is lower than the air bearing surface 51a and forms a stepped portion with the air bearing surface 51a. The head element 12 is provided on the air bearing surface 51a closer to the air outlet end 10b of the head slider 50. The step surface 51b is formed so as to substantially surround the front, rear and sides of the air bearing surface 51a, and includes a step surface portion 51b-1 at the rear closer to the air outlet end 10b of the head slider 50. In other words, the step surface 51b exists on both sides of the air bearing surface 51a in the direction taken along the width of the head slider 50, and in the front and rear of the air bearing surface 51a respectively closer to the air inlet end 10a and the air outlet end 10b of the head slider 50.

Accordingly, even if an alignment error is generated in the direction towards the air outlet end 10b when forming the air bearing surface 51a, the effects on the flying height is virtually prevented by the provision of the step surface portion 51b-1. The width of the step surface portion 51b-1, in a direction taken along the width of the head slider 50, is set to 1 μm or greater at the narrowest portion, and preferably to 5 μm or greater, and more preferably to 10 μm or greater.

When forming the head slider 50 this modification, an alumina layer 15-1 which covers the head element 12 is formed to a thickness which is thicker than the alumina layer 15 by an amount corresponding to the width of the step surface portion 51b-1. For example, if the width of the step surface portion 51b-1 on the side of the air outlet end 10b is 10 μm, the alumina layer 15-1 is formed to a thickness of 30 μm. A portion of the alumina layer 15-1 or all of the alumina layer 15-1 may be replaced by an aluminum nitride layer. Since the thermal conductivity of the aluminum nitride layer is approximately 100 W/(m·K) and higher than the thermal conductivity of the alumina layer 15-1 which is approximately 15 W/(m·K), the aluminum nitride layer can easily release the heat generated from the thin film inductive recording element and avoid the tip end of the head element 12 from projecting due to thermal expansion and avoid thermal damage to the GMR reproducing element.

In the embodiment and modification described above, the head element 12 is provided on the read center rail 18 or 51 of the head slider 10 or 50. However, the head element 12 may be provided on one of the two rear side rails 19 or, on both of the two rear side rails 19. Furthermore, the present invention is not limited to the head sliders 10 and 50 having the rear center rails 18 and 51, and the present invention is similarly applicable to head sliders which do not have a rear center rail.

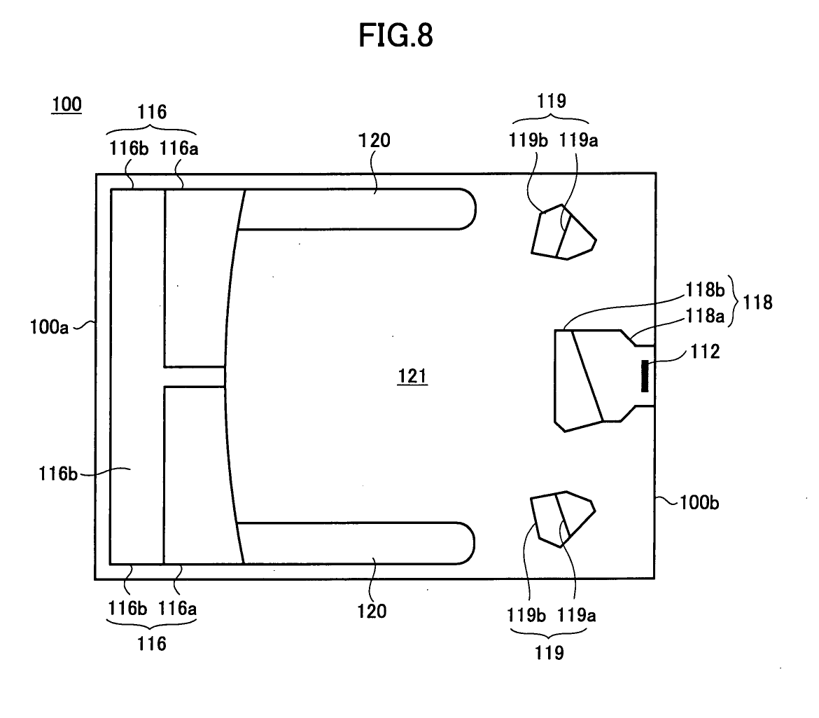

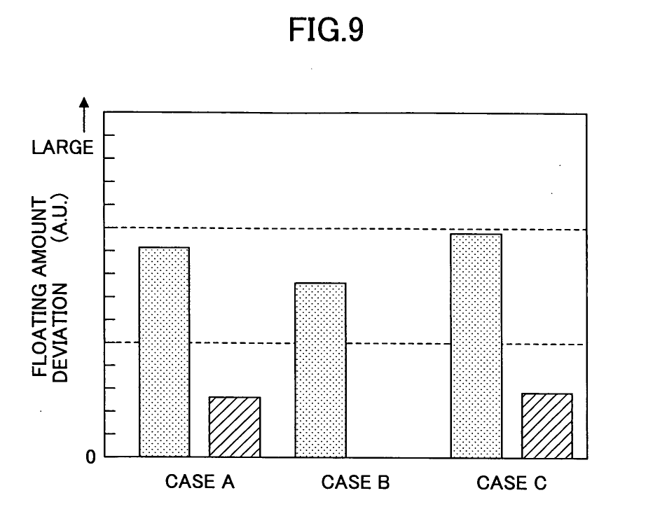

Next, a description will be given of a comparison of the variations in the head flying heights of the embodiment of the head slider described above and a comparison example of a head slider, by referring to FIGS. 8 and 9. FIG. 8 is a diagram showing a medium opposing surface of the comparison example of the head slider. FIG. 9 is a diagram showing floating characteristics of the embodiment of the head slider and the comparison example of the head slider. As will be described later, FIG. 9 shows the effects of an alignment error of a photomask on the flying height obtained by simulations.

The head slider 10 of the embodiment has the medium opposing surface 13 shown in FIG. 3. The medium opposing surface 13 was made to a length of 1.25 mm and a width of 1.00 mm, by taking the length and the width in the same directions as the length and the width of the head slider 10. The air bearing surfaces 16a, 18a and 19a of the front rail 16, the rear center rail 18 and the two rear side rails 19 were respectively made to have areas of 0.16 mm², 0.016 mm² and 0.016 mm². For example, the minimum width X1 of the step surface 16b shown in FIG. 3 was set to 30 μm. A step or height difference between the air bearing surfaces 16a, 18a and 19a and the corresponding step surfaces 16b, 18b and 19b was set to 0.12 μm.

On the other hand, a head slider 100 of the comparison example shown in FIG. 8 had a front rail 116, a rear center rail 118, a pair of rear side rails 119, a pair of side rails 120, and a groove 121. The front rail 116 includes a pair of air bearing surfaces 116a and a step surface 116b which is provided in front of the air bearing surfaces 116a on the side of an air inlet end 100a. No step surface is provided on the sides of the air bearing surfaces 116a nor the rear of the air bearing surfaces 116a on the side of an air outlet end 100b. Similarly, the rear center rail 118 includes an air bearing surface 118a, and a step surface 118b provided in front of the air bearing surface 118a on the side of the air inlet end 100a. No step surface is provided on the sides of the air bearing surface 118a nor the rear of the air bearing surface 118a on the side of the air outlet end 100b. In addition, each rear side rail 119 includes an air bearing surface 119a, and a step surface 119b provided in front of the air bearing surface 119a on the side of the air inlet end 100a. No step surface is provided on the sides of the air bearing surface 119a nor the rear of the air bearing surface 119a on the side of the air outlet end 100b. In other words, none of the air bearing surfaces 116a, 118a and 119a are surrounded by the corresponding step surfaces 116b, 118b and 119b.

The flying height of the head slider 10 of the embodiment and the flying height of the head slider 100 of the comparison example were obtained by simulations using a known calculation program for calculating a flying height of a head slider. The simulations were performed for a Case A where the position of the pattern of each step surface deviates in the longitudinal direction of the head slider, a Case B where the position of the pattern of each step surface deviates in the direction taken along the width of the head slider, and a Case C where the width of the pattern of each step surface deviates. It was assumed for the sake of convenience that the pattern of each air bearing surface is formed at the predetermined designed position with the predetermined designed width, without deviation. For example, the deviation of the width of the pattern of each step surface occurs when the reduction ratio of the reducing optical system exposure apparatus deviates from a predetermined reduction ratio.

In FIG. 9, the ordinate indicates a flying height deviation of the embodiment and the comparison example in arbitrary units (A.U.), and the abscissa indicates the embodiment and the comparison example for the Cases A, B and C. The flying height deviation corresponds to the deviation or variance of the flying height. In FIG. 9, the flying height deviation of the embodiment is indicated by bars with hatching, and the flying height deviation of the comparison example is indicated by shaded bars.

As may be seen from FIG. 9, the flying height deviation of the embodiment is greatly reduced for all of the three Cases A, B and C when compared to the flying height deviation of the comparison example. More particularly, the flying height deviation of the embodiment for the Case A is reduced to approximately 30% of that of the comparison example. It may easily be understood that the reduction in the flying height deviation of the embodiment is due to the step surface 16b which is also formed in the rear of the air bearing surface 16a on the side of the air outlet end 10b as shown in FIG. 3, while the comparison example has the groove 121 in the rear of the air bearing surface 116a and the step surface 116b is only formed in front of the air bearing surface 116a on the side of the air inlet end 100a. It may also be understood that the step surface 19b formed in the rear of the air bearing surface 19a on the side of the air outlet end 10b of each rear side rail 19 similarly contributes to the reduction in the flying height deviation of the embodiment.

On the other hand, the flying height deviation of the embodiment for the Case B is reduced to approximately 10% of that of the comparison example. It may easily be understood that the reduction in the flying height deviation of the embodiment is due to the step surface 16b which is also formed on both sides of the pair of air bearing surfaces 16a as shown in FIG. 3, while the comparison example does not have a step surface formed on both sides of the air bearing surface 116a and the step surface 116b is only formed in front of the air bearing surface 116a on the side of the air inlet end 100a. It may also be understood that the step surface 18a formed on both sides of the air bearing surface 18a of the rear center rail 18 and the step surface 19b formed on both sides of the air bearing surface 19a of each rear side rail 19 similarly contribute to the reduction in the flying height deviation of the embodiment.

Furthermore, the flying height deviation of the embodiment for the Case C is reduced to approximately 30% of that of the comparison example. It may easily be understood that the reduction in the flying height deviation of the embodiment is due to the step surfaces 16b, 18b and 19c which substantially surround the corresponding air bearing surfaces 16a, 18a and 19c of the front rail 16, the rear center rail 18 and the rear side rails 19 as shown in FIG. 3, while the comparison example has the air bearing surfaces 116a, 118a and 119a which have large portions that are not surrounded by the corresponding step surfaces 116b, 118b and 119b.

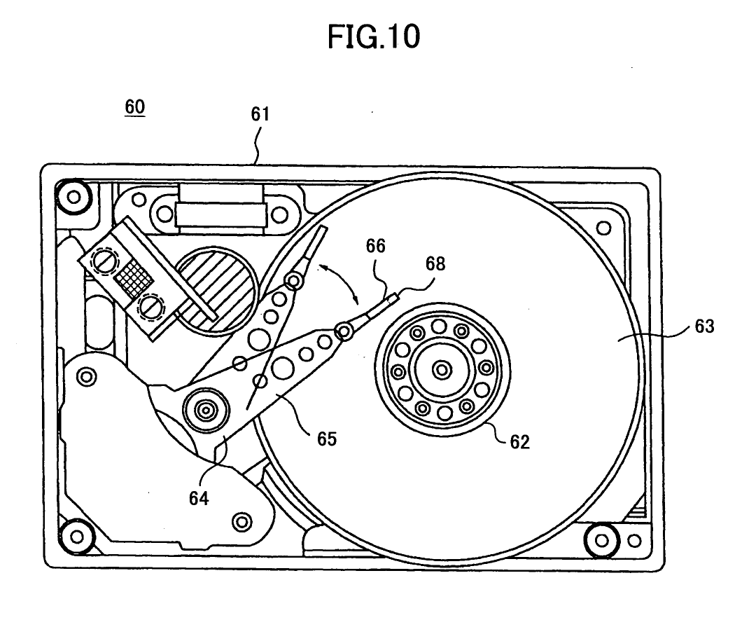

Next, a description will be given of the embodiment of the magnetic storage apparatus according to the present invention, by referring to FIG. 10. FIG. 10 is a plan view showing a part of this embodiment of the magnetic storage apparatus. In this embodiment of the magnetic storage apparatus, the present invention is applied to a magnetic disk drive.

A magnetic storage apparatus 60 shown in FIG. 10 generally includes a housing 61. Inside this housing 61, there are provided a hub 62 which is driven by a known driving means such as a spindle motor (not shown), at least one magnetic disk 63 which is provided as the magnetic recording medium and is fixed on the hub 62 to be rotated thereby, an actuator unit 64, an arm 65 which is mounted on the actuator unit 64 and is movable in a radial direction of the magnetic disk 63, a head suspension 66 which is mounted on the arm 65, and a head slider 68 which is supported by the head suspension 66. The basic construction of this magnetic storage apparatus 60 is known, and a detailed description thereof will be omitted in this specification.

The magnetic disk 63 may be used for longitudinal magnetic recording or for perpendicular magnetic recording. The magnetic disk 63 used for the longitudinal magnetic recording has a recording layer having magnetizations parallel to a substrate surface, and this recording layer may be formed by a single magnetic or ferromagnetic layer, a stacked structure made up of a plurality of magnetic or ferromagnetic layers which are stacked or, a stacked ferrimagnetic structure made up of upper and lower magnetic or ferromagnetic layers which are exchange-coupled via a nonmagnetic layer such as a Ru layer which is 0.6 nm to 0.9 nm thick, for example. In the case of the stacked ferrimagnetic structure, magnetization directions of the upper and lower magnetic or ferromagnetic layers may be mutually antiparallel in a state where no recording magnetic field is applied on the magnetic disk 63. An underlayer may be provided under the recording layer. This underlayer may be made of Cr or Cr alloy having an added element such as W and Mo, for example, so that the magnetization of the recording layer is oriented in an in-plane direction parallel to the substrate surface.

On the other hand, the magnetic disk 63 used for the perpendicular magnetic recording has a recording layer having magnetizations perpendicular to the substrate surface. An underlayer is provided below the recording layer. The underlayer is made of a nonmagnetic material such as Co, Cr, Ru, Re, Ri, Hf and alloys thereof. For example, the underlayer is may have a thickness of 2 nm to 30 nm when made of Ru, RuCo or CoCr.

The recording layer of the magnetic disk 63 may be made of Ni, Fe, Co, Ni alloy, Fe alloy or Co alloy, regardless of whether the magnetic disk 63 is for the longitudinal magnetic recording or for the perpendicular magnetic recording. The Co alloy used for the recording layer may be CoCrTa, CoCrPt or CoCrPt-M, where M denotes an element selected from a group consisting of B, Mo, Nb, Ta, W, Cu and alloys thereof. The recording layer may have a thickness of 3 nm to 30 nm.

The magnetic storage apparatus 60 of this embodiment is characterized by the head slider 68. The head slider 68 has the structure of the head slider 10 of the embodiment described above or the structure of the head slider 50 of the modification of the embodiment described above.

The basic construction of the magnetic storage apparatus 60 is not limited to that shown in FIG. 10. In addition, the magnetic recording medium used in the present invention is not limited to the magnetic disk 63. For example, the magnetic recording medium may be a magneto-optical disk.

According to this embodiment, the inconsistency in the flying height of each of the individual head sliders is suppressed, and the production yield of the head slider and the magnetic storage apparatus is improved. Hence, even if the head slider is designed to operate with an extremely small flying height, it is possible to avoid the head slider and the head element from crashing to the magnetic recording medium, and to realize a high-density recording.

The magnetic storage apparatus may employ the so-called ramp load and unload system which recedes the head slider in a region outside the region of the magnetic recording medium when the magnetic storage apparatus does not operate or is in a standby or sleep state. In this case, a ramp member or the like may be provided to lock the head suspension or the like in the receded position of the head slider.

In each of the embodiment and the modification of the head slider, each air bearing surface is substantially surrounded by the corresponding step surface in each of the front rail, the rear center rail and the rear side rails. However, the air bearing surface may be substantially surrounded by the corresponding step surface in at least one of the front rail, the rear center rail and the rear side rails.

Further, the present invention is not limited to these embodiments, but various variations and modifications may be made without departing from the scope of the present invention.

1. A head slider comprising:
a medium opposing surface configured to confront and float from a surface of a recording medium, said medium opposing surface having an air inlet end and an air outlet end with respect to an air flow between the medium opposing surface and the recording medium;
a front rail, disposed on the medium opposing surface in a vicinity of the air inlet end, and having a first air bearing surface and a first step surface which forms a stepped portion with the first air bearing surface, said first air bearing surface being higher than the first step surface relative to the medium opposing surface; and
a rear rail, disposed on the medium opposing surface in a vicinity of the air outlet end, and having a second air bearing surface and a second step surface which forms a stepped portion with the second air bearing surface, said second air bearing surface being higher than the second step surface relative to the medium opposing surface,
said first air bearing surface being substantially surrounded by the first step surface.

2. The head slider as claimed in claim 1, wherein a minimum width of the first step surface surrounding the first air bearing surface is 1 μm to 50 μm.

3. The head slider as claimed in claim 1, wherein said second air bearing surface is substantially surrounded by the second step surface.

4. The head slider as claimed in claim 3, wherein a minimum width of the second step surface surrounding the second air bearing surface is 1 μm to 50 μm.

5. The head slider as claimed in claim 1, wherein said second air bearing surface is substantially surrounded by the second step surface except for a portion on a side of the air outlet end.

6. The head slider as claimed in claim 1, wherein:
said rear rail comprises a center rail and a pair of side rails disposed on both sides of the center rail,
said rear rail has a second air bearing surface and a second step surface which forms a stepped portion with the second air bearing surface, and
each of said side rails has a second air bearing surface and a second step surface which forms a stepped portion with the second air bearing surface.

7. The head slider as claimed in claim 6, wherein the second air bearing surface of said center rail is substantially surrounded by the second step surface of said center rail except for a portion on a side of the air outlet end, and the second air bearing surface of each side rail is substantially surrounded by the second step surface of the side rail.

8. The head slider as claimed in claim 6, wherein the second air bearing surface of said center rail is substantially surrounded by the second step surface of said center rail, and the second air bearing surface of each side rail is substantially surrounded by the second step surface of the side rail.

9. The head slider as claimed in claim 6, further comprising:
a head element disposed on the medium opposing surface closer to the air outlet end than the center rail.

10. The head slider as claimed in claim 6, wherein said center rail is disposed closer to the air outlet end than said pair of side rails.

11. A magnetic storage apparatus comprising:
a recording medium having a surface; and
a head slider configured to be movable with respect to the recording medium at a floating distance from the surface of the recording medium,
said head slider comprising:
a medium opposing surface configured to confront and float from the surface of the recording medium, said medium opposing surface having an air inlet end and an air outlet end with respect to an air flow between the medium opposing surface and the recording medium;
a front rail, disposed on the medium opposing surface in a vicinity of the air inlet end, and having a first air bearing surface and a first step surface which forms a stepped portion with the first air bearing surface, said first air bearing surface being higher than the first step surface relative to the medium opposing surface; and
a rear rail, disposed on the medium opposing surface in a vicinity of the air outlet end, and having a second air bearing surface and a second step surface which forms a stepped portion with the second air bearing surface, said second air bearing surface being higher than the second step surface relative to the medium opposing surface,
said first air bearing surface being substantially surrounded by the first step surface.

12. The magnetic storage apparatus as claimed in claim 11, wherein the second air bearing surface of said head slider is substantially surrounded by the second step surface.

13. The magnetic storage apparatus as claimed in claim 11, wherein:
the rear rail of said head slider comprises a center rail and a pair of side rails disposed on both sides of the center rail,
the rear rail has a second air bearing surface and a second step surface which forms a stepped portion with the second air bearing surface, and
each of said side rails has a second air bearing surface and a second step surface which forms a stepped portion with the second air bearing surface.

14. The magnetic storage apparatus as claimed in claim 13, wherein said head slider further comprises a head element disposed on the medium opposing surface closer to the air outlet end than the center rail.

15. A head slider producing method comprising the steps of:
(a) forming a first resist layer pattern on a medium opposing surface of a block which includes a head element and is to form a head slider;
(b) etching the medium opposing surface using the first resist layer pattern as a mask to form an air bearing surface;
(c) removing the first resist layer pattern and forming a second resist layer pattern which is larger than the air bearing surface and completely covers the air bearing surface; and
(d) etching the medium opposing surface using the second resist layer pattern as a mask to form a step surface which forms a stepped portion with the air bearing surface, so that the air bearing surface is substantially surrounded by the step surface.

16. The head slider producing method as claimed in claim 15, further comprising:
(e) forming a plurality of head elements on a substrate;
(f) cutting the substrate into a plurality of bars each having a row of head elements; and
(g) cutting the bar along cutting surfaces into a plurality of blocks which are to form head sliders,
said step (a) forming the first resist layer pattern on one of the plurality of blocks.
